(19) United States
(12) Patent Application Publication
(10) Pub. No.: US 2021/0200538 A1
(43) Pub. Date: Jul. 1, 2021

(54) DUAL WRITE MICRO-OP QUEUE

(71) Applicant: Intel Corporation, Santa Clara, CA (US)

(72) Inventors: Franck SALA, Haifa (IL); Lihu RAPPOPORT, Haifa (IL)

(21) Appl. No.: 16/729,362

(22) Filed: Dec. 28, 2019

(51) Int. Cl. G06F 9/22; G06F 9/38; G06F 12/0871

(52) U.S. Cl. CPC G06F 9/223; G06F 12/0871; G06F 9/3851; G06F 9/3855

(57) ABSTRACT

Disclosed embodiments relate to systems and methods to dually write micro-ops to a micro-op queue. A processor includes a micro-op cache communicatively coupled, via a first write port, to a micro-op queue, and a legacy fetch and decode pipeline communicatively coupled, via a second write port, to the micro-op queue, the processor to determine whether the micro-op cache stores a thread, the thread comprising a micro-op to be written to the micro-op queue, determine whether the legacy fetch and decode pipeline stores the thread if the micro-op cache does not store the thread, and write, via the micro-op queue, the micro-op from the thread to the micro-op queue responsive to the determination of whether the micro-op cache or the legacy fetch and decode pipeline stores the thread.

### FIELD OF INVENTION

The field of invention relates generally to computer processor architecture, and, more specifically, to systems and methods for dually writing micro-ops to a micro-op queue.

### BACKGROUND

Microprocessors include instruction pipelines in order to increase the bandwidth of the front-end and the instructions per cycle (IPC). Instructions are provided to the front-end of the pipeline and micro-ops are prepared and queued for execution. Instruction pipelines usually include a number of arrays, buffers, fetch units, and decoders.

Some techniques for increasing the front-end bandwidth are based on increasing the bandwidth of the micro-op cache and/or increasing the bandwidth of the legacy fetch and decode pipeline by, for example, widening the instruction cache fetch bandwidth and adding more instruction decoders or implementing a steam cache. However, the micro-op cache and the legacy fetch and decode pipeline cannot write to the micro-op queue in parallel, thereby, limiting the frontend bandwidth.

Efficiently writing micro-ops to a micro-op queue in parallel may assist in meeting the needs of processors, for example, performing workloads with large and small working sets or other demands requiring an increased frontend bandwidth.

### BRIEF DESCRIPTION OF THE DRAWINGS

The present invention is illustrated by way of example and are not limitations in the figures of the accompanying drawings, in which like references indicate similar elements and in which:

FIG. 1 illustrates a block diagram of a dual write micro-op system according to one embodiment of the invention;

FIG. 2 illustrates examples of embodiments of a method of dually writing micro-ops to a micro-op queue according to a multi-thread mode as detailed herein;

FIG. 3 illustrates a block diagram of a dual write micro-op system according to a single thread mode as detailed herein;

FIG. 4A is a block diagram illustrating both an exemplary in-order pipeline and an exemplary register renaming, out-of-order issue/execution pipeline according to embodiments of the invention;

FIG. 4B is a block diagram illustrating both an exemplary embodiment of an in-order architecture core and an exemplary register renaming, out-of-order issue/execution architecture core to be included in a processor according to embodiments of the invention;

FIGS. 5A-B illustrate a block diagram of a more specific exemplary in-order core architecture, which core would be one of several logic blocks (including other cores of the same type and/or different types) in a chip;

FIG. 6 is a block diagram of a processor 1700 that may have more than one core, may have an integrated memory controller, and may have integrated graphics according to embodiments of the invention;

FIGS. 7-10 are block diagrams of exemplary computer architectures; and

FIG. 11 is a block diagram contrasting the use of a software instruction converter to convert binary instructions in a source instruction set to binary instructions in a target instruction set according to embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The dual write micro-op system is a front-end system that writes micro-ops from a thread in the legacy fetch and decode pipeline and from a thread in the micro-op cache to a micro-op queue in parallel. As used herein, the term “micro-op,” may be used to refer to a program instruction that may be produced by decoding a complex instruction (e.g., a macro instruction). As used herein, the term “legacy fetch and decode pipeline,” may be used to refer to a fetch and decode pipeline to decode instructions to micro-ops that are provided to the micro-op queue and/or the micro-op cache.

Writing to the micro-op queue in parallel as described herein provides for performance improvements by increasing the front-end bandwidth. Further embodiments advantageously increase the instructions per cycle (IPC).

For example, a dual write micro-op system starts with selecting a first thread from a micro-op cache associated with a first write port and selecting a second thread from a legacy fetch and decode pipeline associated with a second write port. Micro-ops are then written to a micro-op queue from the first thread and the second thread in parallel.

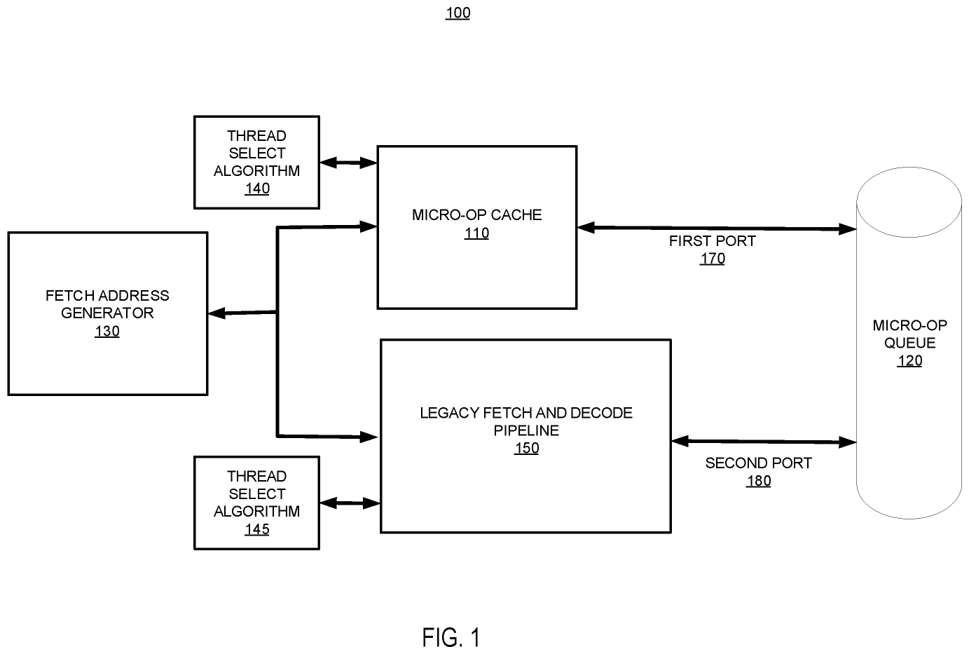

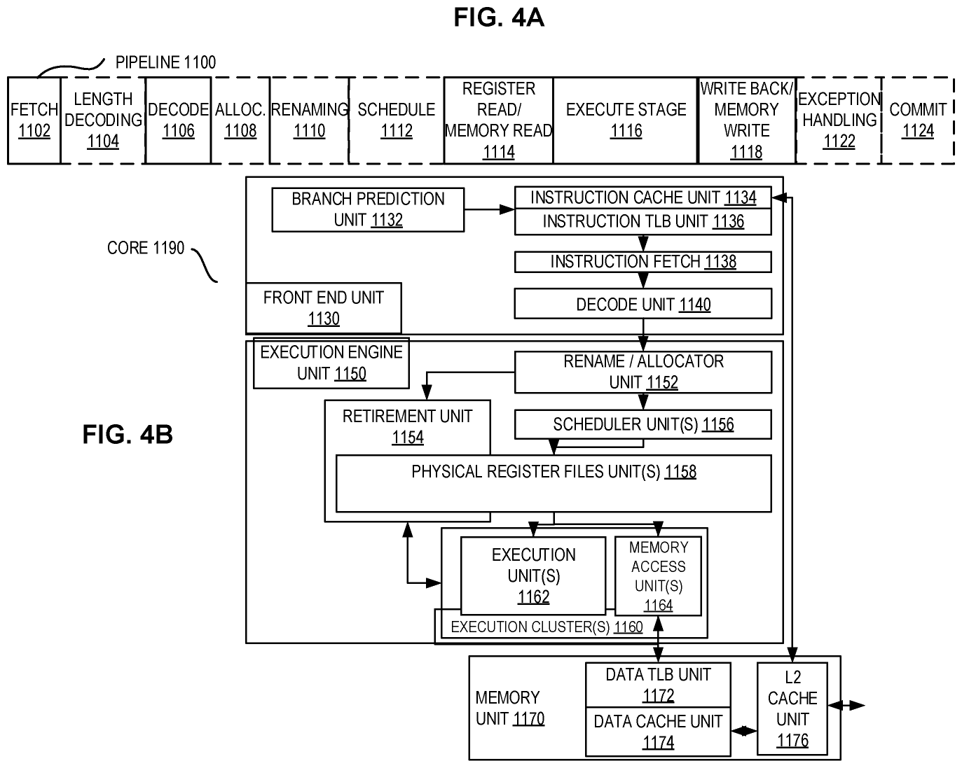

FIG. 1 illustrates a block diagram of a dual write micro-op system 100 (e.g., a system structured to write micro-ops that may be produced by decoding complex instructions to a micro-op queue in parallel) according to one embodiment of the invention. As shown, the dual write micro-op system 100 includes a micro-op cache 110 communicably and operatively coupled to a micro-op queue 120, a legacy fetch and decode pipeline 150, a fetch address generator 130, and one or more additional systems, components, etc. It should be understood that the dual write micro-op system 100 may include additional, less, and/or different components/systems than depicted in FIG. 1 and FIGS. 4A, B (e.g., the components/systems such as, but not limited to, the fetch 1102, length decoding 1104, decode 1106, instruction cache unit 1134, instruction TLB unit 1136, instruction fetch 1138, decode unit 1140, and execution unit 1150), such that the principles, methods, systems, processes, and the like of the present disclosure are intended to be applicable with any other dual write micro-op system configuration. It should also be understood that the principles of the present disclosure contemplates that the principles may also be applied to a variety of other applications.

The dual write micro-op system 100 may be operable in single thread mode or multi-thread mode. In this regard, micro-ops may be written to the micro-op queue 120 in both the single thread mode and the multi-thread mode. In the single thread mode, a single pipeline (e.g., the legacy fetch and decode pipeline 150 or the micro-op cache 110) may write a micro-op to the micro-op queue 120 per cycle. In some embodiments, a micro-op may be written from the micro-op cache 110 and the legacy pipeline in the single thread mode during the same cycle. In this regard, the dual write micro-op system 100 may pre-determine (e.g., calculate in advance) one or more entries in the micro-op queue 120 that can be used for the legacy fetch and decode pipeline 150. The one or more entries in the micro-op queue 120 may then be reserved in advance and one or more micro-ops may be written from both pipelines such that the legacy fetch and decode pipeline 150 may utilize the reserved entries and the micro-op cache 110 may utilize one or more entries after the one or more reserved entries in the micro-op queue 120. In multi-thread mode, the legacy fetch and decode pipeline 150 and the micro-op cache 110 may write a micro-op in parallel to the micro-op queue 120 per cycle.

As shown, the dual write micro-op system 100 includes the micro-op queue 120, a memory array that includes a series of memory locations. The micro-op queue 120 may receive micro-ops stored in the micro-op cache 110, the legacy fetch and decode pipeline 150, or a combination thereof. The micro-op queue 120 may store one or more of the received micro-ops in a memory array. The micro-op queue 120 may include X number of memory locations from a scalable floor to a scalable ceiling depending on the components necessary to execute the dual write micro-op system 100.

In some embodiments, the micro-op queue 120 may include one or more pointers. For example, the micro-op queue 120 may include a read pointer, a write pointer, or any other suitable pointer. The write pointer may indicate the memory location to which the micro-op from the micro-op cache 110, the legacy fetch and decode pipeline 150, or a combination thereof should be written. In some embodiments, after a micro-op is written to a memory location in the micro-op queue 120, the write pointer may be advanced to an available memory location (e.g., the next memory location) to store the next micro-op.

As depicted, the micro-op queue 120 is communicatively coupled, via a first port 170 (e.g., a first write port), to the micro-op cache 110. The micro-op queue 120 is communicatively coupled, via a second port 180 (e.g., a second write port), to the legacy fetch and decode pipeline 150. In such embodiments, the micro-op cache 110 and the legacy fetch and decode pipeline 150 may be coupled to the micro-op queue 120 directly or indirectly via one or more other (e.g., additional, less, and/or different) components/systems than depicted in FIG. 1. Advantageously, micro-ops may be written to the micro-op queue 120 from the micro-op cache 110 and the legacy fetch and decode pipeline 150 at the same time without the need for synchronization.

The micro-op queue 120 may be located at the end of the front-end unit (e.g., the front-end unit 1130 as depicted in FIG. 4A, B) of the dual write micro-op system 100. Alternatively or additionally, the micro-op queue 120 may be implemented at any point in the dual write micro-op system 100 such that the position of the micro-op queue 120 is only exemplary.

As shown, the dual write micro-op system 100 includes the micro-op cache 110. As used herein, the term “micro-op cache” may be used to refer to a cache structured to store one or more micro-ops (e.g., program instructions) of decoded instructions. The micro-ops may be received from the legacy fetch and decode pipeline 150. The micro-op cache 110 may record, copy, and/or store a micro-op from the legacy fetch and decode pipeline 150. The micro-ops may be stored in a cache line.

A tag corresponding to an instruction pointer may be used to lookup the micro-ops such that the associated macro-instruction is not decoded each time. For example, the micro-op cache 110 records (e.g., copies) the micro-ops that are initially provided by the legacy fetch and decode pipeline 150. When that micro-op is needed again, the recorded (e.g., stored) micro-op may be obtained from the micro-op cache 110. In further embodiments, when an instruction needs to be decoded, the micro-op cache 110 may be checked for the decoded micro-op. If the micro-op is in the micro-op cache 110, that micro-op from the micro-op cache 110 is utilized. If the micro-op is not in the micro-op cache 110, the micro-op may be decoded and then cached or stored in the micro-op cache 110.

In some embodiments, the micro-op cache 110 may take the form of a shorter pipeline than the legacy fetch and decode pipeline 150. In some embodiments, the micro-op cache 110 and the legacy fetch and decode pipeline 150 may exchange synchronization signals when the front-end has to switch between the micro-op cache 110 and the legacy fetch and decode pipeline 150.

In some embodiments, the micro-op cache 110 includes the fetch address generator 130. The fetch address generator 130 is to generate an address corresponding to a thread. In some examples, the fetch address generator may generate one or more addresses that correspond to a first thread, second thread, or N number of threads. The fetch address generator may generate an address as needed by the dual write system 100.

As depicted, the fetch address generator 130 is located at the front of the front-end unit of the dual write micro-op system 100; however, the fetch address generator 130 may be communicably and operatively coupled to the micro-op cache 110 and/or the legacy fetch and decode pipeline 150 from an arrangement other than the arrangement depicted in FIG. 1.

In some embodiments, the fetch address generator 130 may include one or more thread select algorithms (e.g., the thread select algorithms 140, 145). Although, in some embodiments, the fetch address generator 130 may not include one or more thread select algorithms, the fetch address generator may be communicatively coupled to the one or more thread select algorithms. The thread select algorithms 140 and 145 may select threads from the micro-op cache 110, the legacy fetch and decode pipeline 150. In some embodiments, the thread select algorithms 140 and 145 may select threads from the micro-op cache 110 and the legacy fetch and decode pipeline 150. Although a plurality of thread select algorithms are depicted, some embodiments may include a single thread select algorithm communicably and operatively coupled to the micro-op cache 110 and/or the legacy fetch and decode pipeline 150 that selects threads from the micro-op cache 110 and/or the legacy fetch and decode pipeline 150. The thread select algorithms 140 and 145 work in parallel. The thread select algorithm 140 selects a thread among the threads that are in the micro-op cache 110. The thread select algorithms 145 selects a thread among the threads that are in the legacy fetch and decode pipeline 150. Advantageously, synchronization is not needed to avoid writing micro-ops from both pipelines at the same time.

### Multi-Thread Mode

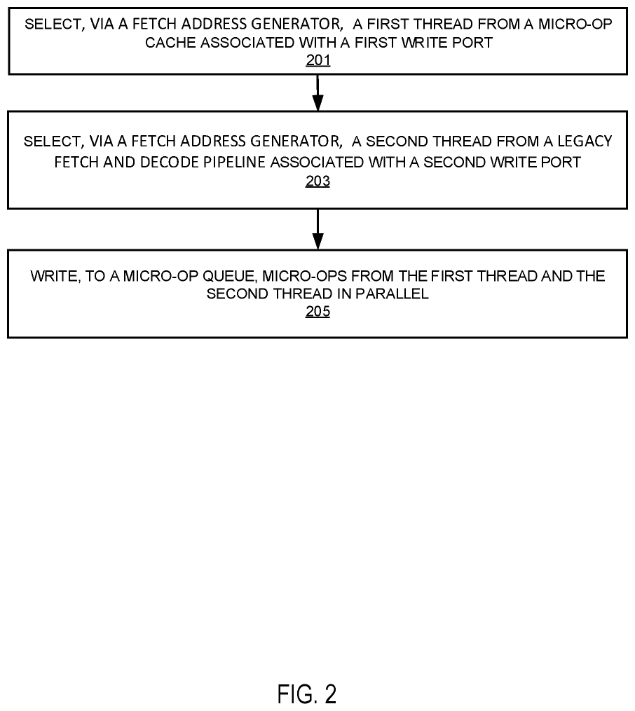

FIG. 2 illustrates examples of embodiments of a method of dually writing micro-ops to a micro-op queue. The processing of the method is performed by components of a processor or core including, but not limited to, a micro-op cache, fetch address generator, legacy fetch and decode pipeline, and a micro-op queue as detailed herein.

At 201, the fetch address generator is to select, retrieve, or otherwise access a thread (e.g., a first thread) included within a micro-op cache. In some embodiments, one or more algorithms (e.g., one or more thread select algorithms) may select threads from the micro-op cache, the legacy fetch and decode pipeline, or a combination thereof. For example, a first thread select algorithm may select a thread from the micro-op cache. A thread may be selected among the threads that have been recorded or otherwise stored in the micro-op cache.

For a given pipeline (e.g., the micro-op cache or the legacy fetch and decode pipeline), one or more thread select algorithms consider the threads that are ready in each respective pipeline for selection of a thread. In some embodiments, a thread select algorithm may select a thread in a round-robin manner. For example, in multi-thread mode, the round robin algorithm may alternate between the threads. In some embodiments, a thread select algorithm may select the Least Recently Used (LRU) thread. For example, the thread select algorithm may maintain a history of the thread selection and may select the thread which has not been selected for the longest period of time.

In some embodiments wherein at least two threads are to be selected (e.g., a thread from the micro-op cache and a thread from the legacy pipeline), a thread select algorithm may be duplicated and utilized in each pipeline. Alternatively or additionally, a single thread select algorithm may select the at least two threads. For example, a single thread select algorithm may select a thread from the legacy pipeline and a thread for the micro-op cache.

The fetch address generator is to select, retrieve, or otherwise access a thread (e.g., a second thread) included within a legacy fetch and decode pipeline at 203. A second thread select algorithm may select the second thread from the legacy fetch and decode pipeline. The second thread may be selected among the threads that are included within the legacy fetch and decode pipeline.

Alternatively or additionally, the second thread select algorithm may select the second thread in parallel to the selection of the first thread by the first thread select algorithm without the need to synchronize thread selection. Advantageously, the selection of the threads without the need to synchronize the thread selection increases the speed by which threads may be selected, fetched, accessed, or otherwise retrieved.

The micro-ops from the first thread and the second thread are written, via a first port and a second port, in parallel to a micro-op queue at 205. In this regard, the micro-op cache is associated with a write port (e.g., a first write port). The legacy fetch and decode pipeline is associated with a second write port (e.g., a second write port). In embodiments wherein a micro-op of a thread (e.g., a first thread) is selected (e.g., fetched) from the micro-op cache and a micro-op from another thread (e.g., a second thread) is selected from the legacy fetch and decode pipeline to write micro-ops to the micro-op queue, the micro-ops are provided in parallel to the micro-op queue. For example, the micro-op queue may receive, via the first write port, a micro-op stored in the micro-op cache and the micro-op queue may receive, via the second write port, a micro-op stored in the legacy fetch and decode pipeline. In turn, the micro-ops are written to the micro-op queue in parallel. The micro-op queue may include a write pointer or any other suitable pointer that may indicate the memory location to which the micro-op from the micro-op cache, the legacy fetch and decode pipeline, or a combination thereof should be written.

### Single Thread Mode

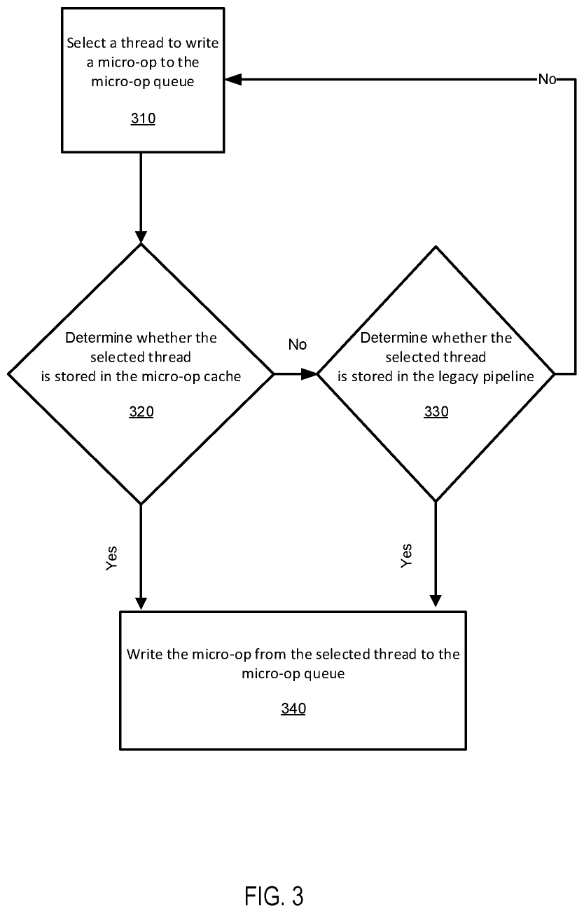

FIG. 3 illustrates an exemplary block diagram illustrating execution of writing a micro-op from a thread to the micro-op queue. A thread select algorithm (e.g., thread select algorithms 140 and 145) may select a thread to write a micro-op to the micro-op queue at 310. The micro-op cache 110 may be checked for the selected thread such that the processor may determine whether the micro-op cache includes (e.g., stores) the thread at 320. If the thread to write the micro-op is in the micro-op cache 110, the micro-op from the selected thread is written to the micro-op queue at 340. The micro-op from the selected thread is written via the first port 170 (e.g., a first write port) corresponding to the micro-op cache 110. If the thread to write the micro-op is not in the micro-op cache 110, the processor may determine whether the thread is in the legacy fetch and decode pipeline 150 at 330. If the thread to write the micro-op is in the legacy fetch and decode pipeline 150, the micro-op from the selected thread is written to the micro-op queue at 340. The micro-op from the thread is written via the second port 180 (e.g., second write port) corresponding to the legacy fetch and decode pipeline 150. If the processor determines that the thread to write the micro-op is not stored in the legacy fetch and decode pipeline 150, the thread select algorithm may select a thread (e.g., a second thread) that includes a micro-op to write to the micro-op queue at 310.

In some embodiments, the micro-op cache 110 may determine (e.g., may pre-determine in advance or in real-time) the number of micro-ops that it needs to send to the micro-op queue 120. Entries for those micro-ops may be reserved in the micro-op queue 120. In turn, the reserved entries may be filled in the micro-op cache 110 and the legacy fetch and decode pipeline 150 may work in parallel such that the micro-ops from the legacy fetch and decode pipeline 150 may be written after the reserved entries.

Detailed herein are examples of hardware, software, etc. to execute the above described instructions. For example, what is described below details aspects of instruction execution including various pipeline stages such as fetch, decode, schedule, execute, retire, etc.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

FIG. 4A is a block diagram illustrating both an exemplary in-order pipeline and an exemplary register renaming, out-of-order issue/execution pipeline according to embodiments of the invention. FIG. 4B is a block diagram illustrating both an exemplary embodiment of an in-order architecture core and an exemplary register renaming, out-of-order issue/execution architecture core to be included in a processor according to embodiments of the invention. The solid lined boxes in FIGS. 4A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 4A, a processor pipeline 1100 includes a fetch stage 1102, a length decode stage 1104, a decode stage 1106, an allocation stage 1108, a renaming stage 1110, a scheduling (also known as a dispatch or issue) stage 1512, a register read/memory read stage 1114, an execute stage 1112, a write back/memory write stage 1118, an exception handling stage 1122, and a commit stage 1124.

FIG. 4B shows processor core 1190 including a front-end unit 1130 coupled to an execution engine unit 1150, and both are coupled to a memory unit 1130. The core 1190 may be a reduced instruction set computing (RISC) core, a complex instruction set computing (CISC) core, a very long instruction word (VLIW) core, or a hybrid or alternative core type. As yet another option, the core 1190 may be a special-purpose core, such as, for example, a network or communication core, compression engine, coprocessor core, general purpose computing graphics processing unit (GPGPU) core, graphics core, or the like.

The front-end unit 1130 includes a branch prediction unit 1132 coupled to an instruction cache unit 1134, which is coupled to an instruction translation lookaside buffer (TLB) 1136, which is coupled to an instruction fetch unit 1138, which is coupled to a decode unit 1140. The decode unit 1140 (or decoder) may decode instructions, and generate as an output one or more micro-operations, micro-code entry points, microinstructions, other instructions, or other control signals, which are decoded from, or which otherwise reflect, or are derived from, the original instructions. The decode unit 1140 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1190 includes a microcode ROM or other medium that stores microcode for certain macroinstructions (e.g., in decode unit 1140 or otherwise within the front-end unit 1130). The decode unit 1140 is coupled to a rename/allocator unit 1152 in the execution engine unit 1150.

The execution engine unit 1150 includes the rename/allocator unit 1152 coupled to a retirement unit 1154 and a set of one or more scheduler unit(s) 1156. The scheduler unit(s) 1156 represents any number of different schedulers, including reservations stations, central instruction window, etc. The scheduler unit(s) 1156 is coupled to the physical register file(s) unit(s) 1158. Each of the physical register file(s) units 1158 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1158 comprises a vector registers unit, a write mask registers unit, and a scalar registers unit. These register units may provide architectural vector registers, vector mask registers, and general purpose registers. The physical register file(s) unit(s) 1158 is overlapped by the retirement unit 1154 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1154 and the physical register file(s) unit(s) 1158 are coupled to the execution cluster(s) 1120. The execution cluster(s) 1120 includes a set of one or more execution units 1122 and a set of one or more memory access units 1124. The execution units 1122 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1156, physical register file(s) unit(s) 1158, and execution cluster(s) 1120 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1124). It should also be understood that where separate pipelines are used, one or more of these pipelines may be out-of-order issue/execution and the rest in-order.

The set of memory access units 1124 is coupled to the memory unit 1130, which includes a data TLB unit 1132 coupled to a data cache unit 1134 coupled to a level 2 (L2) cache unit 1136. In one exemplary embodiment, the memory access units 1124 may include a load unit, a store address unit, and a store data unit, each of which is coupled to the data TLB unit 1132 in the memory unit 1130. The instruction cache unit 1134 is further coupled to a level 2 (L2) cache unit 1136 in the memory unit 1130. The L2 cache unit 1136 is coupled to one or more other levels of cache and eventually to a main memory.

By way of example, the exemplary register renaming, out-of-order issue/execution core architecture may implement the pipeline 1100 as follows: 1) the instruction fetch 1138 performs the fetch and length decoding stages 1102 and 1104; 2) the decode unit 1140 performs the decode stage 1106; 3) the rename/allocator unit 1152 performs the allocation stage 1108 and renaming stage 1110; 4) the scheduler unit(s) 1156 performs the schedule stage 1512; 5) the physical register file(s) unit(s) 1158 and the memory unit 1130 perform the register read/memory read stage 1114; the execution cluster 1120 perform the execute stage 1112; 6) the memory unit 1130 and the physical register file(s) unit(s) 1158 perform the write back/memory write stage 1118; 7) various units may be involved in the exception handling stage 1122; and 8) the retirement unit 1154 and the physical register file(s) unit(s) 1158 perform the commit stage 1124.

The core 1190 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 1190 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 1134/1134 and a shared L2 cache unit 1136, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

Specific Exemplary in-Order Core Architecture

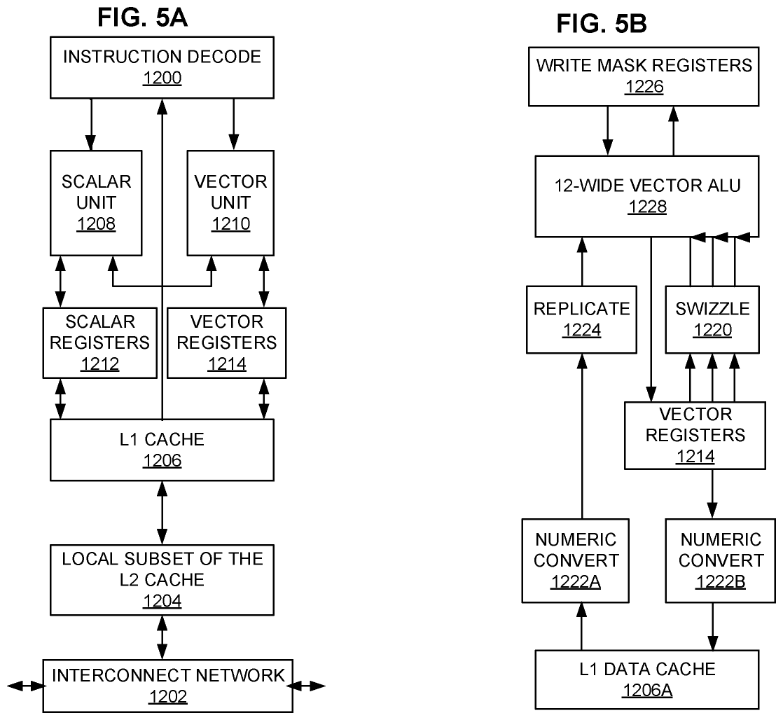

FIGS. 5A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 5A is a block diagram of a single processor core, along with its connection to the on-die interconnect network 1202 and with its local subset of the Level 2 (L2) cache 1204, according to embodiments of the invention. In one embodiment, an instruction decoder 1200 supports the x86 instruction set with a packed data instruction set extension. An L1 cache 1206 allows low-latency accesses to cache memory into the scalar and vector units. While in one embodiment (to simplify the design), a scalar unit 1208 and a vector unit 1210 use separate register sets (respectively, scalar registers 1212 and vector registers 1214) and data transferred between them is written to memory and then read back in from a level 1 (L1) cache 1206, alternative embodiments of the invention may use a different approach (e.g., use a single register set or include a communication path that allow data to be transferred between the two register files without being written and read back).

The local subset of the L2 cache 1204 is part of a global L2 cache that is divided into separate local subsets, one per processor core. Each processor core has a direct access path to its own local subset of the L2 cache 1204. Data read by a processor core is stored in its L2 cache subset 1204 and can be accessed quickly, in parallel with other processor cores accessing their own local L2 cache subsets. Data written by a processor core is stored in its own L2 cache subset 1204 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

Figure SB is an expanded view of part of the processor core in FIG. 5A according to embodiments of the invention. Figure SB includes an L1 data cache 1206A part of the L1 cache 1204, as well as more detail regarding the vector unit 1210 and the vector registers 1214. Specifically, the vector unit 1210 is a 12-wide vector processing unit (VPU) (see the 12-wide ALU 1228), which executes one or more of integer, single-precision float, and double-precision float instructions. The VPU supports swizzling the register inputs with swizzle unit 1220, numeric conversion with numeric convert units 1222A-B, and replication with replication unit 1224 on the memory input. Write mask registers 1226 allow predicating resulting vector writes.

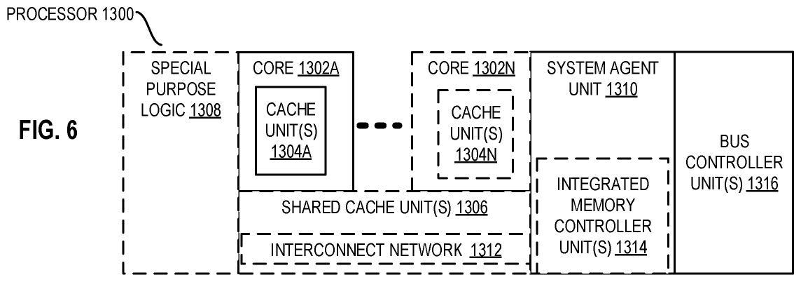

FIG. 6 is a block diagram of a processor 1300 that may have more than one core, may have an integrated memory controller, and may have integrated graphics according to embodiments of the invention. The solid lined boxes in FIG. 6 illustrate a processor 1300 with a single core 1302A, a system agent 1310, a set of one or more bus controller units 1312, while the optional addition of the dashed lined boxes illustrates an alternative processor 1300 with multiple cores 1302A-N, a set of one or more integrated memory controller unit(s) 1314 in the system agent unit 1310, and special purpose logic 1308.

Thus, different implementations of the processor 1300 may include: 1) a CPU with the special purpose logic 1308 being integrated graphics and/or scientific (throughput) logic (which may include one or more cores), and the cores 1302A-N being one or more general purpose cores (e.g., general purpose in-order cores, general purpose out-of-order cores, a combination of the two); 2) a coprocessor with the cores 1302A-N being a large number of special purpose cores intended primarily for graphics and/or scientific (throughput); and 3) a coprocessor with the cores 1302A-N being a large number of general purpose in-order cores. Thus, the processor 1300 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1300 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1306, and external memory (not shown) coupled to the set of integrated memory controller units 1314. The set of shared cache units 1306 may include one or more mid-level caches, such as level 2 (L2), level 3 (L3), level 4 (L4), or other levels of cache, a last level cache (LLC), and/or combinations thereof. While in one embodiment a ring based interconnect unit 1312 interconnects the integrated graphics logic 1308 (integrated graphics logic 1308 is an example of and is also referred to herein as special purpose logic), the set of shared cache units 1306, and the system agent unit 1310/integrated memory controller unit(s) 1314, alternative embodiments may use any number of well-known techniques for interconnecting such units. In one embodiment, coherency is maintained between one or more cache units 1306 and cores 1302-A-N.

In some embodiments, one or more of the cores 1302A-N are capable of multi-threading. The system agent 1310 includes those components coordinating and operating cores 1302A-N. The system agent unit 1310 may include for example a power control unit (PCU) and a display unit. The PCU may be or include logic and components needed for regulating the power state of the cores 1302A-N and the integrated graphics logic 1308. The display unit is for driving one or more externally connected displays.

The cores 1302A-N may be homogenous or heterogeneous in terms of architecture instruction set; that is, two or more of the cores 1302A-N may be capable of execution the same instruction set, while others may be capable of executing only a subset of that instruction set or a different instruction set.

### Exemplary Computer Architectures

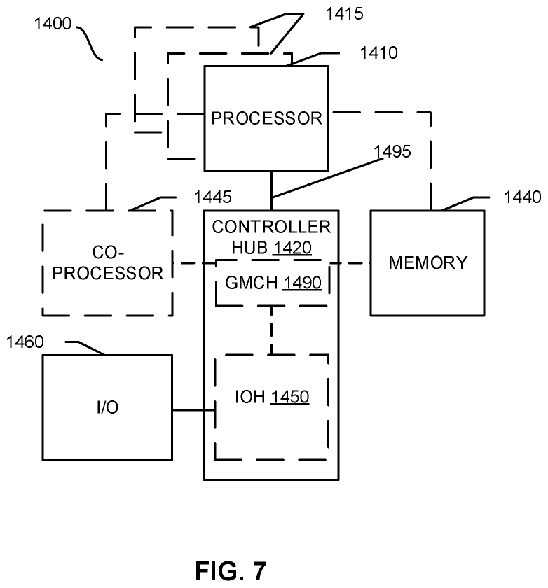

FIGS. 7-10 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 7, shown is a block diagram of a system 1400 in accordance with one embodiment of the present invention. The system 1400 may include one or more processors 1410, 1415, which are coupled to a controller hub 1420. In one embodiment the controller hub 1420 includes a graphics memory controller hub (GMCH) 1490 and an Input/Output Hub (IOH) 1450 (which may be on separate chips); the GMCH 1490 includes memory and graphics controllers to which are coupled memory 1440 and a coprocessor 1445; the IOH 1450 couples input/output (I/O) devices 1460 to the GMCH 1490. Alternatively, one or both of the memory and graphics controllers are integrated within the processor (as described herein), the memory 1440 and the coprocessor 1445 are coupled directly to the processor 1410, and the controller hub 1420 in a single chip with the IOH 1450.

The optional nature of additional processors 1415 is denoted in FIG. 7 with broken lines. Each processor 1410, 1415 may include one or more of the processing cores described herein and may be some version of the processor 1300.

The memory 1440 may be, for example, dynamic random access memory (DRAM), phase change memory (PCM), or a combination of the two. For at least one embodiment, the controller hub 1420 communicates with the processor(s) 1410, 1415 via a multi-drop bus, such as a frontside bus (FSB), point-to-point interface such as QuickPath Interconnect (QPI), or similar connection 1495.

In one embodiment, the coprocessor 1445 is a special-purpose processor, such as, for example, a high-throughput MIC processor, a network or communication processor, compression engine, graphics processor, GPGPU, embedded processor, or the like. In one embodiment, controller hub 1420 may include an integrated graphics accelerator.

There can be a variety of differences between the physical resources 1410, 1415 in terms of a spectrum of metrics of merit including architectural, microarchitectural, thermal, power consumption characteristics, and the like.

In one embodiment, the processor 1410 executes instructions that control data processing operations of a general type. Embedded within the instructions may be coprocessor instructions. The processor 1410 recognizes these coprocessor instructions as being of a type that should be executed by the attached coprocessor 1445. Accordingly, the processor 1410 issues these coprocessor instructions (or control signals representing coprocessor instructions) on a coprocessor bus or other interconnect, to coprocessor 1445. Coprocessor(s) 1445 accept and execute the received coprocessor instructions.

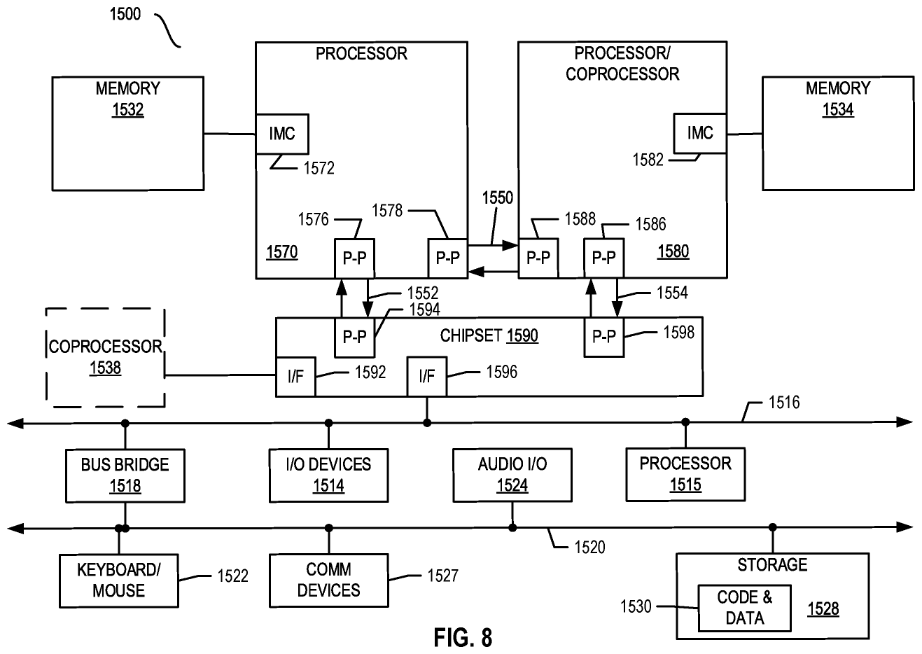

Referring now to FIG. 8, shown is a block diagram of a first more specific exemplary system 1500 in accordance with an embodiment of the present invention. As shown in FIG. 8, multiprocessor system 1500 is a point-to-point interconnect system, and includes a first processor 1570 and a second processor 1580 coupled via a point-to-point interconnect 1550. Each of processors 1570 and 1580 may be some version of the processor 1300. In one embodiment of the invention, processors 1570 and 1580 are respectively processors 1410 and 1415, while coprocessor 1538 is coprocessor 1445. In another embodiment, processors 1570 and 1580 are respectively processor 1410 coprocessor 1445.

Processors 1570 and 1580 are shown including integrated memory controller (IMC) units 1572 and 1582, respectively. Processor 1570 also includes as part of its bus controller units point-to-point (P-P) interfaces 1576 and 1578; similarly, second processor 1580 includes P-P interfaces 1586 and 1588. Processors 1570, 1580 may exchange information via a point-to-point (P-P) interface 1550 using P-P interface circuits 1578, 1588. As shown in FIG. 8, IMCs 1572 and 1582 couple the processors to respective memories, namely a memory 1532 and a memory 1534, which may be portions of main memory locally attached to the respective processors.

Processors 1570, 1580 may each exchange information with a chipset 1590 via individual P-P interfaces 1552, 1554 using point to point interface circuits 1576, 1594, 1586, 1598. Chipset 1590 may optionally exchange information with the coprocessor 1538 via a high-performance interface 1592. In one embodiment, the coprocessor 1538 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1590 may be coupled to a first bus 1516 via an interface 1596. In one embodiment, first bus 1516 may be a Peripheral Component Interconnect (PCI) bus, or a bus such as a PCI Express bus or another third generation I/O interconnect bus, although the scope of the present invention is not so limited.

As shown in FIG. 8, various I/O devices 1514 may be coupled to first bus 1516, along with a bus bridge 1514 which couples first bus 1516 to a second bus 1520. In one embodiment, one or more additional processor(s) 1515, such as coprocessors, high-throughput MIC processors, GPGPU's, accelerators (such as, e.g., graphics accelerators or digital signal processing (DSP) units), field programmable gate arrays, or any other processor, are coupled to first bus 1516. In one embodiment, second bus 1516 may be a low pin count (LPC) bus. Various devices may be coupled to a second bus 1516 including, for example, a keyboard and/or mouse 1518, communication devices 1527 and a storage unit 1528 such as a disk drive or other mass storage device which may include instructions/code and data 1530, in one embodiment. Further, an audio I/O 1524 may be coupled to the second bus 1516. Note that other architectures are possible. For example, instead of the point-to-point architecture of FIG. 8, a system may implement a multi-drop bus or other such architecture.

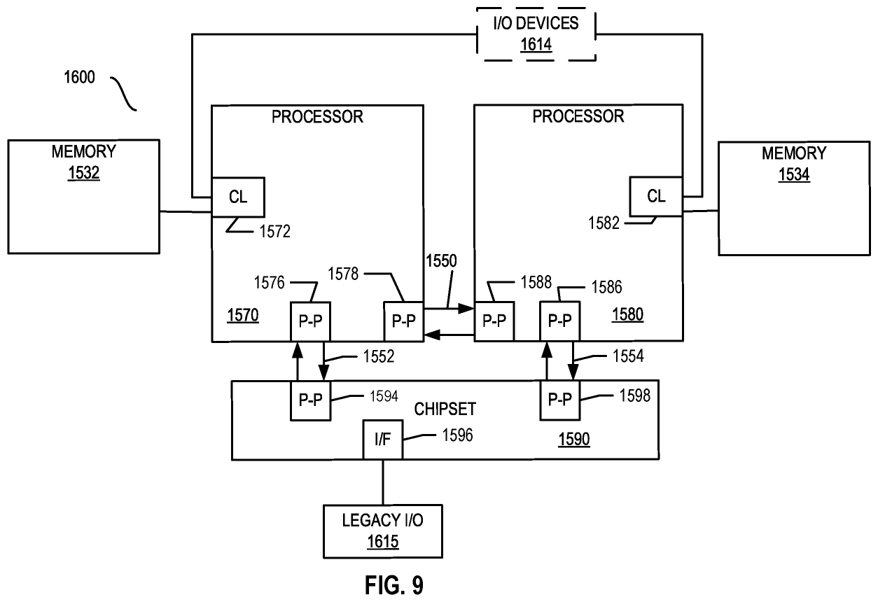

Referring now to FIG. 9, shown is a block diagram of a second more specific exemplary system 1600 in accordance with an embodiment of the present invention. Like elements in FIGS. 8 and 9 bear like reference numerals, and certain aspects of FIG. 8 have been omitted from FIG. 9 in order to avoid obscuring other aspects of FIG. 9.

FIG. 9 illustrates that the processors 1570, 1580 may include integrated memory and I/O control logic (“CL”) 1572 and 1582, respectively. Thus, the CL 1572, 1582 include integrated memory controller units and include I/O control logic. FIG. 9 illustrates that not only are the memories 1532, 1534 coupled to the CL 1572, 1582, but also that I/O devices 1614 are also coupled to the control logic 1572, 1582. Legacy I/O devices 1615 are coupled to the chipset 1590.

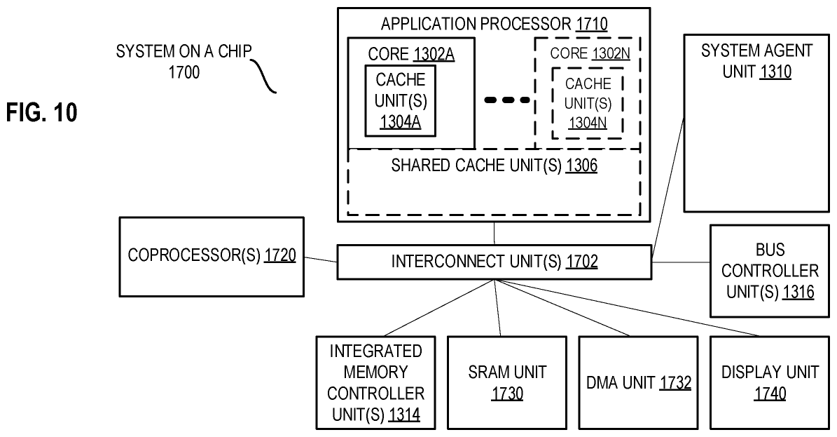

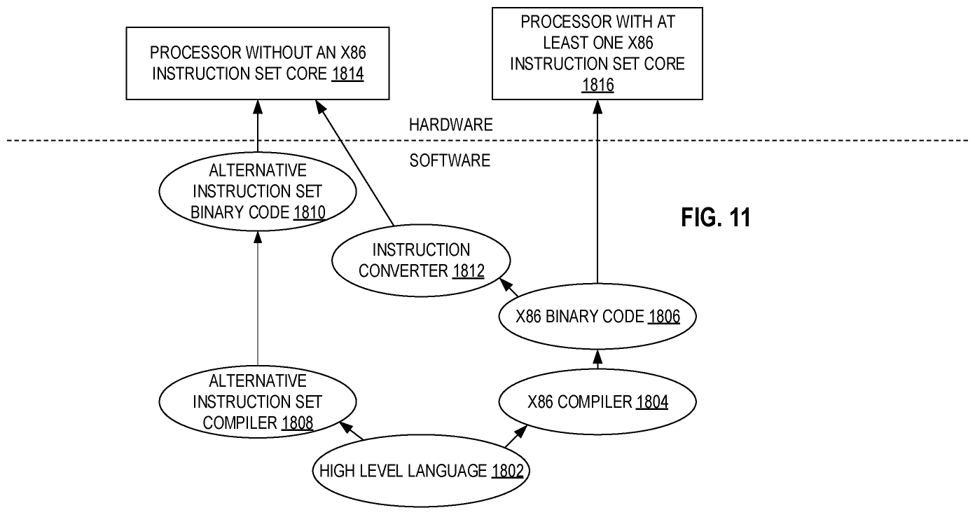

Referring now to FIG. 10, shown is a block diagram of a SoC 1700 in accordance with an embodiment of the present invention. Similar elements in FIG. 6 bear like reference numerals. Also, dashed lined boxes are optional features on more advanced SoCs. In FIG. 10, an interconnect unit(s) 1702 is coupled to: an application processor 1710 which includes a set of one or more cores 1302A-N, which include cache units 1304A-N, and shared cache unit(s) 1306; a system agent unit 1310; a bus controller unit(s) 1316; an integrated memory controller unit(s) 1314; a set or one or more coprocessors 1716 which may include integrated graphics logic, an image processor, an audio processor, and a video processor; an static random access memory (SRAM) unit 1730; a direct memory access (DMA) unit 1732; and a display unit 1740 for coupling to one or more external displays. In one embodiment, the coprocessor(s) 1720 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1530 illustrated in FIG. 8, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMS) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 7 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 7 shows a program in a high level language 1762 may be compiled using an x86 compiler 1764 to generate x86 binary code 1766 that may be natively executed by a processor with at least one x86 instruction set core 1776. The processor with at least one x86 instruction set core 1776 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1764 represents a compiler that is operable to generate x86 binary code 1766 (e.g., object code) that can, with or without additional linkage processing, be executed on the processor with at least one x86 instruction set core 1776. Similarly, FIG. 7 shows the program in the high level language 1762 may be compiled using an alternative instruction set compiler 1768 to generate alternative instruction set binary code 1770 that may be natively executed by a processor without at least one x86 instruction set core 1774 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1772 is used to convert the x86 binary code 1766 into code that may be natively executed by the processor without an x86 instruction set core 1774. This converted code is not likely to be the same as the alternative instruction set binary code 1770 because an instruction converter capable of this is difficult to make; however, the converted code will accomplish the general operation and be made up of instructions from the alternative instruction set. Thus, the instruction converter 1772 represents software, firmware, hardware, or a combination thereof that, through emulation, simulation or any other process, allows a processor or other electronic device that does not have an x86 instruction set processor or core to execute the x86 binary code 1766.

### Further Examples

Example 1. A processor comprising a micro-op cache communicatively coupled, via a first write port, to a micro-op queue; and a legacy fetch and decode pipeline communicatively coupled, via a second write port, to the micro-op queue, the processor to: determine, via a first thread select algorithm, whether the micro-op cache stores a thread, the thread comprising a micro-op to be written to the micro-op queue; determine, via a second thread select algorithm, whether the legacy fetch and decode pipeline stores the thread if the micro-op cache does not store the thread; and write, via the micro-op queue communicatively coupled to the first write port corresponding to the micro-op cache or the second write port corresponding to the legacy fetch and decode pipeline, the micro-op from the thread to the micro-op queue in response to the determination of whether the micro-op cache or the legacy fetch and decode pipeline stores the thread.

Example 2. The processor of example 1, further comprising a fetch address generator to: select the thread to write the micro-op to the micro-op queue; and generate an address corresponding to the thread.

Example 3. The processor of example 2, wherein the fetch address generator determines that the legacy fetch and decode pipeline does not comprise the selected thread, and the fetch address generator selects a second thread, the second thread comprising the micro-op to be written to the micro-op queue.

Example 4. The processor of example 1, wherein the micro-op cache stores the selected thread, and wherein the micro-op is written, via the first write port, from the selected thread to the micro-op queue.

Example 5. The processor of example 1, wherein the legacy fetch and decode pipeline is to decode an instruction, and wherein the decoded instruction comprises the micro-op.

Example 6. The processor of example 1, wherein the micro-op cache is to determine the number of micro-ops to send to the micro-op queue.

Example 7. The processor of example 1, wherein the processor is operable in single thread mode or multi-thread mode.

Example 8. The processor of example 7, wherein a single micro-op from the micro-op cache is written to the micro-op queue per cycle in the single thread mode, and wherein micro-ops from the legacy fetch and decode pipeline and the micro-op cache are written in parallel to the micro-op queue per cycle in multi-thread mode.

Example 9. A method comprising: selecting, via a fetch address generator, a first thread from a micro-op cache associated with a first write port; selecting, via the fetch address generator, a second thread from a legacy fetch and decode pipeline associated with a second write port; and writing, via a micro-op queue, micro-ops from the first thread and the second thread in parallel.

Example 10. The method of example 9, wherein a first thread select algorithm corresponding to the fetch address generator is to select, from the micro-op cache, the first thread to write a first micro-op to the micro-op queue.

Example 11. The method of example 9, wherein a second thread select algorithm corresponding to the fetch address generator is to select the second thread to write, from the legacy fetch and decode pipeline, a second micro-op to the micro-op queue.

Example 12. The method of example 9, further comprising generating an address corresponding to the first thread and generating an address corresponding to the second thread.

Example 13. The method of example 9, wherein the micro-ops are written, via the first port and the second port, from the first thread and the second thread to the micro-op queue in parallel.

Example 14. The method of example 9, wherein the micro-op cache is to store one or more micro-ops, and wherein the one or more micro-ops comprise one or more decoded instructions.

Example 15. The method of example 14, wherein the micro-op cache is to record the one or more micro-ops from the legacy fetch and decode pipeline.

Example 16. A system comprising: a memory; and a processor comprising: a micro-op cache communicatively coupled, via a first write port, to a micro-op queue; and a legacy fetch and decode pipeline communicatively coupled, via a second write port, to the micro-op queue, the processor to: select, via a first thread select algorithm, a first thread from a micro-op cache associated with a first write port; select, via second thread select algorithm, a second thread from a legacy fetch and decode pipeline associated with a second write port; and write, to a micro-op queue, micro-ops from the first thread and the second thread in parallel.

Example 17. The system of example 16, wherein the micro-ops are written, via the first port and the second port, from the first thread and the second thread to the micro-op queue in parallel.

Example 18. The system of example 16, wherein the micro-op cache is to store one or more micro-ops, and wherein the one or more micro-ops comprise one or more decoded instructions.

Example 19. The system of example 16, wherein the micro-op cache is to record one or more micro-ops from the legacy fetch and decode pipeline.

Example 20. The system of example 16, wherein the processor is operable in single thread mode or multi-thread mode.

What is claimed is:

1. A processor comprising:
a micro-op cache communicatively coupled, via a first write port, to a micro-op queue; and
a legacy fetch and decode pipeline communicatively coupled, via a second write port, to the micro-op queue, the processor to:
determine, via a first thread select algorithm, whether the micro-op cache stores a thread, the thread comprising a micro-op to be written to the micro-op queue;
determine, via a second thread select algorithm, whether the legacy fetch and decode pipeline stores the thread if the micro-op cache does not store the thread; and
write, via the micro-op queue communicatively coupled to the first write port corresponding to the micro-op cache or the second write port corresponding to the legacy fetch and decode pipeline, the micro-op from the thread to the micro-op queue in response to the determination of whether the micro-op cache or the legacy fetch and decode pipeline stores the thread.

2. The processor of claim 1, further comprising a fetch address generator to:
select the thread to write the micro-op to the micro-op queue; and
generate an address corresponding to the thread.

3. The processor of claim 2, wherein the fetch address generator determines that the legacy fetch and decode pipeline does not comprise the selected thread, and the fetch address generator selects a second thread, the second thread comprising the micro-op to be written to the micro-op queue.

4. The processor of claim 1, wherein the micro-op cache stores the selected thread, and wherein the micro-op is written, via the first write port, from the selected thread to the micro-op queue.

5. The processor of claim 1, wherein the legacy fetch and decode pipeline is to decode an instruction, and wherein the decoded instruction comprises the micro-op.

6. The processor of claim 1, wherein the micro-op cache is to determine the number of micro-ops to send to the micro-op queue.

7. The processor of claim 1, wherein the processor is operable in single thread mode or multi-thread mode.

8. The processor of claim 7, wherein a single micro-op from the micro-op cache is written to the micro-op queue per cycle in the single thread mode, and wherein micro-ops from the legacy fetch and decode pipeline and the micro-op cache are written in parallel to the micro-op queue per cycle in multi-thread mode.

9. A method comprising:
selecting, via a fetch address generator, a first thread from a micro-op cache associated with a first write port;
selecting, via the fetch address generator, a second thread from a legacy fetch and decode pipeline associated with a second write port; and
writing, to a micro-op queue, micro-ops from the first thread and the second thread in parallel.

10. The method of claim 9, wherein a first thread select algorithm corresponding to the fetch address generator is to select, from the micro-op cache, the first thread to write a first micro-op to the micro-op queue.

11. The method of claim 9, wherein a second thread select algorithm corresponding to the fetch address generator is to select the second thread to write, from the legacy fetch and decode pipeline, a second micro-op to the micro-op queue.

12. The method of claim 9, further comprising generating an address corresponding to the first thread and generating an address corresponding to the second thread.

13. The method of claim 9, wherein the micro-ops are written, via the first port and the second port, from the first thread and the second thread to the micro-op queue in parallel.

14. The method of claim 9, wherein the micro-op cache is to store one or more micro-ops, and wherein the one or more micro-ops comprise one or more decoded instructions.

15. The method of claim 14, wherein the micro-op cache is to record the one or more micro-ops from the legacy fetch and decode pipeline.

16. A system comprising:
a memory; and
a processor comprising:
a micro-op cache communicatively coupled, via a first write port, to a micro-op queue; and
a legacy fetch and decode pipeline communicatively coupled, via a second write port, to the micro-op queue, the processor to:
select, via a first thread select algorithm, a first thread from a micro-op cache associated with a first write port;
select, via second thread select algorithm, a second thread from a legacy fetch and decode pipeline associated with a second write port; and
write, to a micro-op queue, micro-ops from the first thread and the second thread in parallel.

17. The system of claim 16, wherein the micro-ops are written, via the first port and the second port, from the first thread and the second thread to the micro-op queue in parallel.

18. The system of claim 16, wherein the micro-op cache is to store one or more micro-ops, and wherein the one or more micro-ops comprise one or more decoded instructions.

19. The system of claim 16, wherein the micro-op cache is to record one or more micro-ops from the legacy fetch and decode pipeline.

20. The system of claim 16, wherein the processor is operable in single thread mode or multi-thread mode.
